(19) United States
(12) Patent Application Publication
(10) Pub. No.: US 2022/0193995 A1
(43) Pub. Date: Jun. 23, 2022

(54) BUILD MATERIAL SPREADER COOLING

(71) Applicant: HEWLETT-PACKARD DEVELOPMENT COMPANY, L.P., Spring, TX (US)

(72) Inventors: Arthur H. BARNES, Vancouver, WA (US); Wesley R. SCHALK, Vancouver, WA (US)

(21) Appl. No.: 17/604,293

(22) PCT Filed: Sep. 19, 2019
(86) PCT No.: PCT/US2019/052027

§ 371 Date: Oct. 15, 2021

(51) Int. Cl. B29C 64/218; B29C 64/214; B29C 64/364; B29C 64/393; B33Y 30/00; B33Y 40/00

(52) U.S. Cl. CPC B29C 64/218; B29C 64/214; B29C 64/364; B33Y 50/02; B33Y 30/00; B33Y 40/00; B29C 64/393

(57) ABSTRACT

A three-dimensional (3D) printer build material spreader cooling system may include a build volume, a build material spreader, a spreader drive, a spreader cooler and a cooling fluid supply. The build material spreader may have a length and a first fluid conduit extending along the length. The spreader drive is to translate the build material spreader across the build volume. The spreader cooler is in thermal conductive contact with the build material spreader. The spreader cooler has a second fluid conduit extending along the length. The cooling fluid supply directs cooling fluid in a first direction through the first fluid conduit and in a second direction, opposite the first direction, through the second fluid conduit.

### BACKGROUND

Three-dimensional printing systems, also referred to as additive manufacturing systems, facilitate the generation of three-dimensional (3D) objects on a layer-by-layer basis. Such 3D printing techniques generate each layer of an object by spreading build material across a build volume and selectively solidifying portions of the layer.

### BRIEF DESCRIPTION OF THE DRAWINGS

FIG. 1 is a block diagram schematically illustrating portions of an example 3D printer build material spreader cooling system.

FIG. 2 is a flow diagram of an example 3D printer build material spreader cooling method.

FIG. 3 is a graph illustrating various temperature profiles along an example build material spreader.

FIG. 4 is a block diagram schematically illustrating portions of an example 3D printer build material spreader cooling system.

FIG. 5 is a schematic diagram illustrating portions of an example 3D printing system.

FIG. 6 is a side view illustrating portions of an example 3D printing system.

FIG. 7 is an end view of the example 3D printing system of FIG. 6 taken along line 7-7.

FIG. 8 is a schematic diagram illustrating portions of an example 3D printing system.

FIG. 9 is an end view of the example 3D printing system of FIG. 8 taken along line 9-9.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example cooling systems, methods and computer-readable mediums that facilitate more reliable and consistent layers of build material to provide more accurate and consistent 3D printing performance. Prior to being spread across a build volume or build bed by build material spreader, the build materials are sometimes heated to remove moisture and/or to facilitate subsequent selective solidification. In some solidification processes, heat is applied to or generated during the selective solidification of the layer. Heat from the build material and/or heat from the solidification process may be absorbed by the build material spreader. As a result, surface temperatures of the build material spreader may increase to a point where the build material sticks to the spreader. For example, surface temperatures of the build material spreader may be high enough such that the build material melts and sticks to the build material spreader. Build material sticking to the spreader may damage subsequent layers by digging into previously formed layers and the solidified objects themselves.

To inhibit the build material from sticking to the spreader, the spreader may be cooled. For example, the surface temperatures of the build material spreader may be cooled to a temperature below the point at which the build material sticks to the spreader. Such cooling may be carried out by directing a cooling fluid, such as a cooling liquid or a cooling gas, at a temperature lower than that of the spreader, through a conduit along a length of the spreader. However, as the cooling fluid flows along the length of the spreader, it absorbs heat. As the cooling fluid heats up, it is less effective at absorbing or removing heat. Consequently, the cooling fluid absorbs a greater amount of heat upon initially entering the spreader and absorbs a lesser amount of heat prior to exiting the spreader. This leads to nonuniform heat absorption along the length of spreader and nonuniform temperatures along the length of the spreader. Such nonuniform temperatures may reduce consistency and uniformity of the layers and the object being formed from such layers.

The disclosed cooling systems, methods and computer-readable mediums address such non-uniform temperatures along the length of the spreader by positioning a spreader cooler in thermally conductive contact with the build material spreader. Cooling fluid is directed through the spreader cooler in a direction opposite to the direction in which the cooling fluid is directed through the spreader. As a result, the spreader cooler provides the build material spreader with more uniform temperatures across its length and across the build volume, facilitating more uniform and consistent build material layers to facilitate more uniform and consistent 3D printed objects.

In some implementations, the disclosed cooling systems, methods and computer-readable mediums sense the temperature of the build material spreader along its length or at different locations along its length. The sensed temperatures are used as a basis for adjusting the supply of cooling fluid through the build material spreader and/or the spreader cooler. Adjusting the supply of cooling fluid may involve adjusting the temperature of the fluid and/or adjusting the velocity of fluid flow. In some implementations, the sensed temperature may additionally be used to adjust the rate at which the spreader is moved across the build volume while the build material spreader is being cooled.

In some implementations, the disclosed cooling systems, methods and computer-readable mediums sense the presence of build material accumulation on the build material spreader and/or sense the presence of grooves other nonuniformities in the build layer itself. The sensed build material or build material nonuniformities are used as a basis for adjusting the supply of cooling fluid through the build material spreader and through the spreader cooler. In some implementations, the sensed accumulation of build material on the build material spreader or the sensed nonuniformity of the build material layer may be used to adjust the rate at which the build material spreader is moved across the build volume while the build material spreader is being cooled. In yet other implementations, a desired thermal profile may be determined experimentally and the system may control the supply of cooling fluid which maintains the desired thermal profile.

For purposes of this disclosure, a build material refers to any material that may be spread and selectively solidified, fused or cured to form a three-dimensional part or object. Such build materials may be in the form of particulates or powders that are selectively fused or bound to one another. Examples of build materials include, but are not limited to, plastics, ceramics and metals. Examples of build materials may further include short fibre build materials that may, for example, have been cut into short lengths from long strands or threads of material.

Disclosed are example 3D printer build material spreader cooling systems. The example systems may include a build volume, a build material spreader, a spreader drive, a spreader cooler and a cooling fluid supply. The build material spreader may have a length and a first fluid conduit extending along the length. The spreader drive is to translate the build material spreader across the build volume. The spreader cooler is in thermal conductive contact with the build material spreader. The spreader cooler has a second fluid conduit extending along the length. The cooling fluid supply directs cooling fluid in a first direction through the first fluid conduit and in a second direction, opposite the first direction, through the second fluid conduit.

Disclosed are example build material spreader cooling methods. The example methods may include translating a build material spreader across a build volume and directing cooling fluid in a first direction along a length of a build material spreading surface. The method may further include directing cooling fluid in a second direction, opposite the first direction, along the length of a spreader cooler that is in thermal conductive contact with the build material spreader.

Disclosed are example non-transitory computer-readable mediums containing instructions for a processor. The example instructions may direct the processor to output control signals directing a cooling fluid supply to supply cooling fluid along a length of a build material spreading surface of a three-dimensional printer build material spreader. The instructions further direct the processor to receive temperature signals from a sensor, the temperature signals indicating a temperature of a build material spreading surface of a three-dimensional printer build material spreader. The instructions direct the processor to output control signals causing the cooling fluid supply to supply cooling fluid to a spreader cooler in thermally conductive contact with the build material spreader based on the temperature signals.

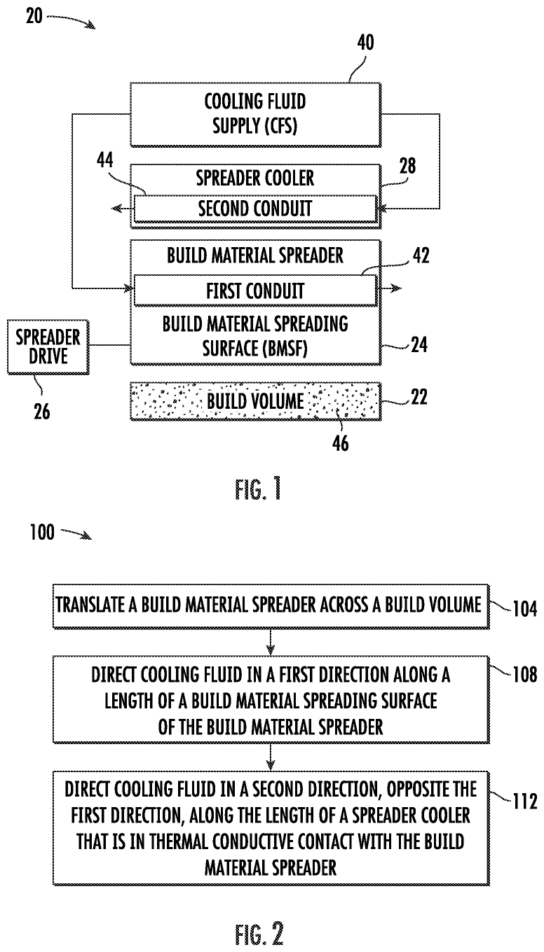

FIG. 1 is a block diagram schematically illustrating portions of an example 3-dimensional (3D) printer build material spreader cooling system 20. System 20 facilitates more uniform and even cooling of a build material spreader to enhance 3D printing performance. System 20 comprises build volume 22, build material spreader 24, spreader drive 26, spreader cooler 28 and cooling fluid supply 40.

Build volume 22, sometimes referred to as a build bed, comprises a chamber to contain the layers of build material 46 formed by build material spreader 24 and selectively solidified or fused to form the three-dimensional part or object. In one implementation, build volume 22 may comprise a movable floor for lowering the current volume of build material within build volume 22 to facilitate the spreading of a new layer of build material across build volume 22 by build material spreader 24.

Build material spreader 24 comprises a structure to spread build material across build volume 22 so as to form a layer of build material for being selectively solidified. Build material spreader 24 has a build material spreading surface which grades or pushes a mound of build material across a build volume, spreading the mound in a layer across the build volume. Build material spreader 24 has an internal fluid conduit 42 through which a cooling fluid may flow. Fluid conduit 42 extends along the length of build material spreader 24. In one implementation, fluid conduit 42 extends along a majority of the length. In one implementation fluid conduit 42 extends along 90% or more of the length of the fluid conduit. In one implementation, fluid conduit 42 has a length equal to or greater than the width of the build volume 22 over which build material spreader 24 is driven. In one implementation, fluid conduit 42 linearly extends from a first end to a second end of build material spreader 24. In other implementations, conduit 42 may have other shapes along its length. For example, conduit 42 may be curved or serpentine along its length.

Spreader drive 26 comprises a linear actuator to linearly translate build material spreader across the length (orthogonal to the width) of the build volume 22. In one implementation, spreader drive 26 may comprise an electrically powered motor and a rack and pinion drive, wherein the build material spreader 24 is connected to a rack gear that is linearly translated by rotation of a pinion gear that is meshed to the rack gear and that is driven by the electrically powered motor. In yet another implementation, spreader drive 26 may comprise an endless belt or cable connected to the build material spreader 24 and driven by an electrically powered motor. In yet other implementations, spreader drive 26 may comprise a hydraulic or pneumatic drive. In still other implementations, spreader drive 26 may comprise other mechanisms for linearly moving build material spreader 24 back and forth across build volume 22.

Spreader cooler 28 comprises a structure in thermal conductive contact with build material spreader 24, facilitating thermal conduction of heat from an outer surface of build material spreader 24 to the outer surface of spreader cooler 28. Spreader cooler 28 comprises a fluid conduit 44 extending within or through spreader cooler 28 along the length of build material spreader 24. Fluid conduit 44 facilitates the flow of a cooling fluid along the length of spreader cooler 28 and along the length of build material spreader 24. In one implementation, fluid conduit 44 has a length equal to or greater than that of conduit 42. In one implementation, fluid conduit 44 extends parallel to fluid conduit 42. In other implementations, conduit 44 may extend oblique to fluid conduit 44, may be curved along its length or may be serpentine along its length.

Cooling fluid supply 40 supplies cooling fluids to conduits 42 and 44. The cooling fluids being supplied to build material spreader 24 and spreader cooler have a temperature less than the temperature of build material spreader 24. As a result, the fluid being circulated through conduits 42 and 44 absorbs and carries away heat. In one implementation, the cooling fluid entering the build material spreader 24 and entering the spreader cooler 28 have temperatures of no greater than 25° C. In one implementation, the temperatures of the cooling fluids exiting conduits 42 and 44 may be 65° C. or greater.

Cooling fluid supply 40 directs cooling fluid in a first direction through fluid conduit 42 and in a second direction, opposite the first direction, through second fluid conduit 44. In one implementation, the cooling fluids directed or circulated through each of conduits 42 and 44 have the same composition. In one implementation, the cooling fluid directed through conduit 42 is returned to cooling fluid supply 40, where it is cooled before being recirculated back through fluid conduit 44. In yet another implementation, cooling fluid directed through conduit 42 has a different composition as compared to the fluid directed through conduit 44.

In one implementation, cooling fluid supply 40 supplies cooling fluid to conduits 42 and 44 independent of one another. For example, in one implementation, cooling fluid supply 40 supplies cooling fluid to conduit 42 at a first temperature and supplies cooling fluid to conduit 44 at a second temperature different than the first temperature. In one implementation, cooling fluid supply 40 supplies cooling fluid conduit 42 at a first rate and supplies cooling fluid to conduit 44 at a second rate different than the first rate.

In one implementation, cooling fluid supply 40 continuously circulates fluid through conduits 42 and 44 in unison. In other implementations, cooling fluid supply 40 may periodically circulate fluid through conduits 42 and 44 in unison. In one implementation, cooling fluid supply 40 supplies and circulates cooling fluid to and through conduits 42 and 44 at different times or during offset periods of time that overlap one another.

In one implementation, the cooling fluid directed through each of conduits 42 and 44 comprises a liquid, such as water. In another implementation, the cooling fluid supplied to each of conduits 42 and 44 comprises a gas, such as air. In yet other implementations, cooling fluid supply 40 may supply and circulate a liquid to and through one of conduits 42, 44 while supplying and circulating a gas to and through the other of conduits 42, 44.

FIG. 2 is a flow diagram illustrating portions of an example method 100 for cooling a build material spreader. As indicated by block 104, a build material spreader may be translated across a build volume. During such translation, build material spreader grades or spreads a mound of build material across the build volume to form a uniform layer of build material for subsequent selective solidification.

As indicated by block 108, a cooling fluid is directed in a first direction along a length of a build material spreading surface of the build material spreader. As indicated by block 112, cooling fluid is directed in a second direction, opposite the first direction, along the length of a spreader cooler that is in thermal conductive contact with the build material spreader. The oppositely directed cooling fluid flowing through the spreader cooler cooperates with the cooling fluid flowing through the build material spreader to present a more uniform temperature gradient across the length of the build material spreading surface of the build material spreader and across the width of the build volume. The more uniform temperature gradient across the build material spreader surface may result in a more uniform build material layer for forming three-dimensional parts or objects.

FIG. 3 is a graph depicting an example temperature profile 120 across the width of build volume 22 of system 20 (shown in FIG. 1) when carrying out method 100. Line 124 represents the temperature of the cooling fluid circulating through conduit 42 across the width of build volume 22. The left side of line 124 corresponds to the temperature of the cooling fluid at the inlet of conduit 42. The right side of line 124 corresponds to the temperature of the cooling fluid at the outlet of conduit 42.

As shown by line 124, as the cooling fluid flows along the length of the spreader, it absorbs heat. This results in the temperature of the cooling fluid increasing as it flows from the inlet towards the outlet of conduit 42. As the cooling fluid heats up, it is less effective at absorbing or removing heat. Consequently, the cooling fluid absorbs a greater amount of heat upon initially entering the spreader and absorbs a lesser amount of heat prior to exiting the spreader. Absent spreader cooler 28 and the cooling fluid flowing in an opposite direction through spreader cooler 28, the build material spreading surfaces might present a nonuniform temperature profile along the length of the build material spreader 24 and across the width of the build volume 22.

Line 126 represents the temperature of the cooling fluid flowing through conduit 44 of spreader cooler 28 along the length of the build material spreading surface of the build material spreader 24. The right side of line 124 corresponds to the temperature the cooling fluid at the inlet of conduit 44. The left side of line 126 corresponds to the temperature of the cooling fluid at the outlet of conduit 44.

Similar to the cooling fluid flowing through conduit 42, the cooling fluid flowing through conduit 44 absorbs heat as it flows from the inlet towards the outlet of conduit 44. As the cooling fluid heats up, it is less effective at absorbing or removing heat. Consequently, the cooling fluid absorbs a greater amount of heat upon initially entering the spreader cooler and absorbs a lesser amount of heat prior to exiting the spreader cooler. As with the cooling fluid being circulated through conduit 42, the cooling fluid being circulated through conduit 44 has a lower temperature proximate the inlet and a higher temperature proximate the outlet.

Because the cooling fluids being circulated through conduits 42 and 44 flow in opposite directions, wherein the inlet of conduit 42 is proximate the outlet of conduit 44 and the outlet of conduit 42 is proximate the inlet of conduit 44, the nonuniform temperature profiles of the cooling fluids flowing through conduits 42 and 44 offset one another. As a result, as indicated by line 128, the build material spreading surface experiences a more uniform temperature gradient or profile across the length of build material spreader 24. The cooling fluid flowing through conduit 42 absorbs a greater amount of heat towards a first end of build material spreader 24 while the cooling fluid flowing through conduit 44 absorbs a greater amount of heat towards a second opposite end of build material spreader 24.

Although the temperature profiles of the fluid flowing through conduits 42 and 44 as indicated by lines 124 and 126 are illustrated as identical to one another, but in opposite directions, it should be appreciated that in other implementations, the temperature profiles of the cooling fluid as indicated by lines 124 and 126 may vary from one another, yet still provide the uniform or level temperature profile as indicated by line 128. In some implementations, the oppositely directed cooling fluids flowing through conduit 42 and 44 may not produce a perfectly level or uniform temperature profile for the build material spreading surface of build material spreader 24, but may still reduce the extent of temperature differences across the length of the build material spreader 24 to still enhance build material layer formation and 3D printing performance.

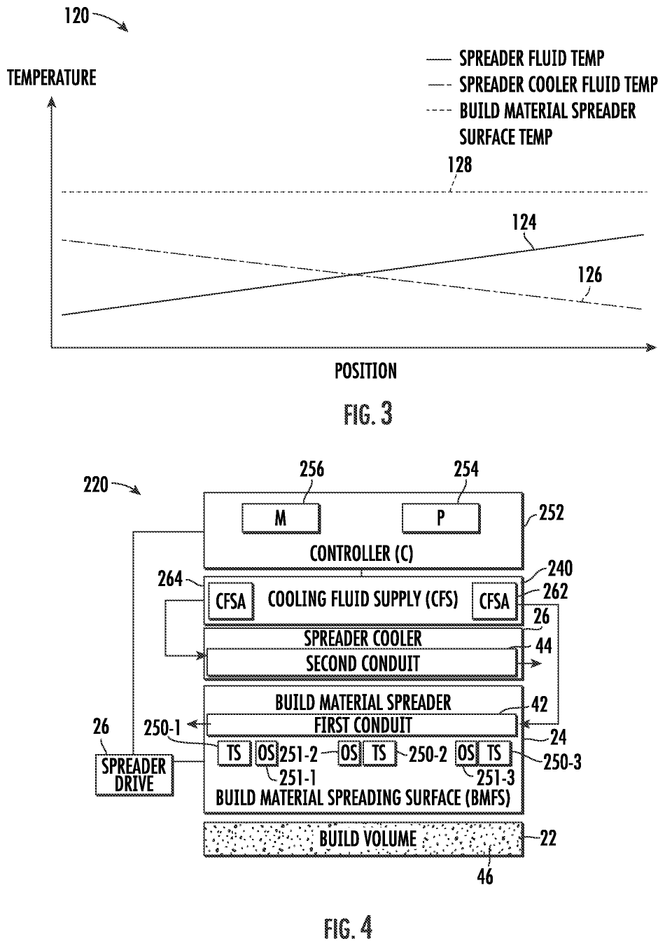

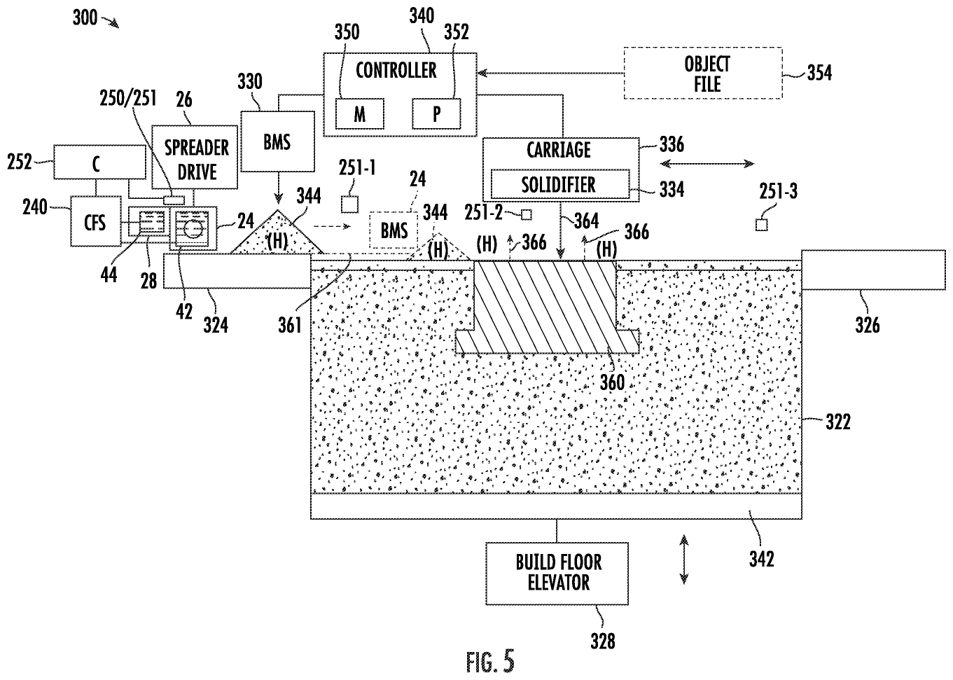

FIG. 4 is a block diagram schematically illustrating portions of an example 3D printer build material spreader cooling system 220. As with system 20, system 220 facilitates more uniform and even cooling of a build material spreader to enhance 3D printing performance. FIG. 4 illustrates how temperature sensing and/or build material sensing may be used to provide automatic closed-loop feedback control over the cooling of the build material spreader. System 220 is similar to system 20 except that system 220 comprises cooling fluid supply 240 in place of cooling fluid supply 40 and additionally comprises temperature sensors 250-1, 250-2, 250-3 (collectively referred to as temperature sensors 250), optical sensors 251-1, 251-2, 251-3 (collectively referred to as optical sensors 251) and controller 252. Those remaining components of system 220 which correspond to components of system 20 are numbered similarly.

Cooling fluid supply 240 is similar to cooling fluid supply 40 described above except the cooling fluid supply 240 is illustrated as additionally comprising independent cooling fluid supply adjusters (CFSA) 262 and 264 for independently adjusting characteristics of the cooling fluid being supplied to conduits 42 and 44, respectively.

In one implementation, cooling fluid adjusters 262 and 264 independently adjust the temperature of the cooling fluid being supplied to conduits 42 and 44, respectively. For example, cooling fluid adjuster 262 may adjust the temperature of the cooling fluid being supplied to conduit 42 to a first temperature while cooling fluid adjuster 264 may adjust the temperature of the cooling fluid being supplied to conduit 44 to a second temperature different than the first temperature. The adjustments are independent of one another in that the temperature of the cooling fluid being supplied to conduit 42 may be adjusted by a first extent or a first number of degrees while the cooling fluid being supplied to conduit 44 is adjusted by a second different extent or a second number of degrees different than the first number of degrees.

For example, in one implementation, cooling fluid supply 240 may receive cooling fluid from both conduits 42 and 44 after the cooling fluid has circulated through conduits 42 and 44. Prior to recirculating the same fluid back to such conduits 42 and 44, the cooling fluid may once again be cooled, wherein the current temperature of the cooling fluid to be transmitted to conduit 42 is sensed and cooled to a first lower temperature while the current temperature of the cooling fluid to be transmitted to conduit 44 is sensed and cooled to a second lower temperature different than the first lower temperature. In some implementations, cooling fluids returning from conduits 42 and 44 are co-mingled or mixed, prior to being once again cooled and recirculated back to conduits 42 and 44. In other implementations, the cooling fluids returning from conduits 42 and 44 remain separate as they are being cooled by cooling fluid supply 240 and as they are recirculated back to conduits 42 and 44. Where the cooling fluids remain separate, the cooling fluids may have different compositions. In implementations where the cooling fluids comprise air, the air used for the cooling fluids may be drawn from the environment. In some implementations, after the air has been directed through conduits 42 and 44 for cooling, the air may be exhausted into the environment.

In one implementation, cooling fluid supply adjusters 262 and 264 may each comprise independently controlled fluid cooling systems. For example, cooling fluid adjusters 262 and 264 may comprise independently controllable lines carrying a refrigerant, wherein the refrigerant flowing through the lines cool the fluids being supplied to conduits 42 and 44. In other implementations, other independently controlled fluid cooling systems or mechanism may be employed by cooling fluid supply adjusters 262 and 264.

In one implementation, cooling fluid supply adjusters 262 and 264 may comprise independent flow adjusters that independently adjust the rate at which the cooling fluid is supplied to conduits 42 and 44, respectively. For example, cooling fluid adjuster 262 may adjust the rate at which the cooling fluid is supplied to conduit 42 to a volume/unit time while cooling fluid adjuster 264 may adjust rate at which the cooling fluid is supplied to conduit 44 to a second volume/unit time different than the volume/unit time. The adjustments are independent of one another in that the rate at which the cooling fluid is supplied to conduit 42 may be adjusted by a first extent while the rate at which the cooling fluid is supplied to conduit 44 is adjusted by a second different extent different than the first extent.

In one implementation, cooling fluid adjuster 262 and 264 may each comprise independently controlled pumps (when the cooling fluid is a liquid) or fans/blowers (when the cooling fluid is a gas). Cooling fluid supply adjusters 262 and 264 may comprise independently controllable valves for independently controlling the supply of cooling fluid to conduits 42 and 44, respectively. In other implementations, other independently controlled fluid flow adjusting or controlling mechanisms may be employed by cooling fluid adjusters 262 and 264. In some implementations, cooling fluid supply adjusters 262 and 264 may differently and independently adjust both the temperature and the flow rate of the cooling fluids being supplied to conduits 42 and 44, respectively.

Temperature sensors 250 and optical sensors 251 output signals that may indicate nonuniform or varying temperatures along the length of the build material spreading surface of build material spreader 24 caused by nonuniform cooling of the build material spreader 24. Temperature sensors 250 comprise sensors that are to output electrical signals corresponding to or indicating the temperature of the build material spreading surface of build material spreader 24. Temperature sensors 250 are spaced along the length of build material spreading surface of build material spreader 24 so as to output different signals indicating the different temperatures of different portions of build material spreader 24 along its length. Such signals are used by controller 252 to control the supply of cooling fluid.

In one implementation, temperature sensors 250 sense the temperature of the build material spreading surface itself. For example, temperature sensor 250 may each comprise an optical temperature sensor, such as infrared temperature sensor, focused on build material spreading surface of build material spreader 24. In one implementation, temperature sensors 250 indirectly sense the temperature of build material spreading surface of build material spreader 24. For example, in one implementation, temperature sensors 250 may sense the temperature of the cooling fluids being circulated through conduit 42 and/or conduit 44 at different locations along the length of build material spreader 24, wherein the different temperatures of the cooling fluids at different points along the conduits 42 and 44 may be correlated to the different temperatures of the build material spreading surface along the length of build material spreader 24.

Although system 220 is illustrated as including three temperature sensors 250, in other implementations, system 220 may include less than three temperature sensors or more than three temperature sensors. In one implementation, system 220 may include a single temperature sensor 250. In yet other implementations, temperature sensors 250 may be omitted.

Optical sensors 251 comprise optical sensors that are to output electrical signals corresponding to or indicating the presence, shape or other characteristic of the build material 46. In one implementation, optical sensors 251 are spaced along the length of build material spreading surface of build material spreader 24 so as to output different signals indicating the presence of build material sticking to different portions of the build material spreading surface of the build material spreader 24 along its length. Such signals are used by controller 252 to control the supply of cooling fluid. For example, in one implementation, optical sensors 251 may comprise cameras or other optical sensing devices focused on this build material spreading surface of build material spreader 24.

In another implementation, optical sensors 250 may be provided at different locations above build volume 22, across the width of build volume 22. Optical sensors 251 output electrical signals indicating the uniformity or levelness of the most recent formed layer of build material within build volume 22. For example, optical sensors 250 may comprise cameras focused on the surface of the build material within build volume 22, wherein the cameras output electrical signals indicating the presence of grooves formed in the layer of build material that may be caused by build material sticking to the build material spreader 24. The signals output by optical sensors 251 are transmitted to controller 252 for use in controlling the supply of cooling fluid to conduits 42 and 44.

Controller 252 controls characteristics of the cooling fluid or fluids being supplied to conduits 42 and 44. Controller 252 comprises processor 254 and a non-transitory computer-readable medium 256. Processor 254 carries out actions in accordance with instructions provided by medium 256. Medium 256 comprises a memory containing instructions or logic circuitry providing such instructions. The instructions direct processor 254 to output control signals that cause cooling fluid supply adjusters 262 and 264 to adjust the characteristic of the cooling fluid supplied to conduits 42 and 44, respectively, based upon the temperature indicating signals received from temperature sensors 250 and/or signals received from optical sensors 251. Such control signals may direct cooling fluid adjuster 262, 264 to differently adjust the temperatures and/or the fluid flow rates of the cooling fluids being supplied to conduits 42 and 44, respectively. In some circumstances, such control signals may direct cooling fluid supply adjusters 262 and 264 to similarly adjust the temperatures and/or fluid flow rates of the cooling fluids being supplied to conduits 42 and 44, respectively.

Because system 220 independently adjust the characteristics (such as temperature and/or flow rate) of the cooling fluids being supplied to conduits 42 and 44, system 220 may address temperature differentials across the length of the build material spreader 24 as indicated by temperature sensors 250. For example, in response to receiving signals from temperature sensors 250 indicating that the temperature of the build material surface proximate to temperature sensor 250-1 is greater than the temperature of the build material surface proximate to temperature sensor 250-3, controller 252 may output control signals causing the temperature of the cooling fluid supplied to conduit 44 to be lowered relative to the temperature of the cooling fluid supplied to conduit 42, thereby absorbing more heat from those regions of the build material spreading surface proximate to temperature sensor 250-1 as compared to those regions of the build material spreading surface proximate to temperature sensor 250-3. In response to receiving signals from temperature sensors 250 indicating that the temperature of the build material surface proximate to temperature sensor 250-1 is greater than the temperature of the build material surface proximate to temperature sensor 250-3, controller 252 may output control signals increasing the rate at which cooling fluid supplied to conduit 44 relative to the rate at which cooling fluid is supplied to conduit 42, thereby absorbing more heat from those regions of the build material spreading surface proximate to temperature sensor 250-1 as compared to those regions of the build material spreading surface proximate to temperature sensor 250-3. In some implementations, in response to such signals, controller 252 may output control signals to cooling fluid supply 240 causing both the rate and the cooling of the cooling fluid being supplied to conduit 44 to be increased.

Conversely, in response to receiving signals from temperature sensors 250 indicating that the temperature of the build material surface proximate to temperature sensor 250-3 is greater than the temperature of the build material surface proximate to temperature sensor 250-1, controller 252 may output control signals causing the temperature of the cooling fluid supplied to conduit 42 to be lowered relative to the temperature of the cooling fluid supplied to conduit 44, thereby absorbing more heat from those regions of the build material spreading surface proximate to temperature sensor 250-3 as compared to those regions of the build material spreading surface proximate to temperature sensor 250-1. In response to receiving signals from temperature sensors 250 indicating that the temperature of the build material surface proximate to temperature sensor 250-3 is greater than the temperature of the build material surface proximate to temperature sensor 250-1, controller 252 may output control signals increasing the rate at which cooling fluid supplied to conduit 42 relative to the rate at which cooling fluid is supplied to conduit 44, thereby absorbing more heat from those regions of the build material spreading surface proximate to temperature sensor 250-3 as compared to those regions of the build material spreading surface proximate to temperature sensor 250-1. In some implementations, in response to such signals, controller 252 may output control signals to cooling fluid supplied 240 causing both the rate and the cooling of the cooling fluid being supplied to conduit 42 to be increased.

In one implementation, in response to receiving signals from optical sensors 251 indicating a greater presence of build material stuck to the material spreader 24 at one end as compared to the other, or in response to signals from optical sensors 251 indicating a greater presence of grooves or unevenness in the layer of the build material itself proximate to one end of the material spreader 24 as compared to the other, controller 252 may output control signals adjusting the supply of cooling fluid to 42 and/or conduit 44 to provide additional cooling to those portions of the build material spreader 24 having the greater presence of build material stuck to the material spreader or having the greater degree or presence of unevenness in the build material layer. For example, in response to optical sensor 251 indicating a greater amount of build material sticking to the build material spreading surface proximate to optical sensor 251-1 as compared to those regions of the build material spreading surface proximate to optical sensor 251-3, or in response to signals from optical sensors 251 indicating a greater presence of grooves or unevenness in the layer of the build material itself proximate to optical sensor 251-1 as compared to the layer build material proximate optical sensor 251-3, controller 252 may output control signals causing the temperature of the cooling fluid supplied to conduit 44 to be lowered relative to the temperature of the cooling fluid supplied to conduit 42, thereby absorbing more heat from those regions of the build material spreading surface proximate to temperature sensor 250-1 as compared to those regions of the build material spreading surface proximate to temperature sensor 250-3.

In response to optical sensors 251 indicating a greater amount of build material sticking to the build material spreading surface proximate to optical sensor 251-1 as compared to those regions of the build material spreading surface proximate to optical sensor 251-3, or in response to signals from optical sensors 251 indicating a greater presence of grooves or unevenness in the layer of the build material itself proximate to optical sensor 251-1 as compared to the layer build material proximate optical sensor 251-3, controller 252 may output control signals increasing the rate at which cooling fluid supplied to conduit 44 relative to the rate at which cooling fluid is supplied to conduit 42, thereby absorbing more heat from those regions of the build material spreading surface proximate to temperature sensor 250-1 as compared to those regions of the build material spreading surface proximate to temperature sensor 250-3. In some implementations, in response to such signals, controller 252 may output control signals to cooling fluid supplied 240 causing both the rate and the cooling of the cooling fluid being supplied to conduit 44 to be increased.

In some circumstances, controller 252 may output control signals causing fluid supply 240 to supply fluid to conduits 42 and 44 so as to raise or lower the overall build material spreading surface temperature, so as to raise or lower the temperature uniformly across the length of spreader 24. For example, in response to the temperature of the build material spreading surface being too high across the length of spreader 24 (as detected by temperature sensors 250) causing the build-up of build material along the length of spreader 24 (as detected by optical sensors 251 or as otherwise determined), controller 252 may output control signals causing fluid supply 240 to lower the temperature of the build material spreading surface uniformly across the length of the build material spreader 24 by lowering the temperature of the cooling fluids being supplied through conduits 42 and 44 and/or increasing the rate at which such cooling fluids are supplied to conduits 42 and 44. In response to spreader 24 dragging 3D objects across the build surface (as detected by optical sensors 251) due to the build material spreading surface being too cold (as detected by temperature sensors 250), controller 252 may output control signals causing fluid supply 240 to increase the temperature of the build material spreading surface uniformly across the length of the build material spreader 24 by increasing the temperature of the cooling fluids being supplied through conduits 42 and 44 and/or reducing the rate at which such cooling fluids are supplied to conduits 42 and 44.

In some implementations, based upon temperature indicating signals from temperature sensor 250 and/or based upon the build material signals received from optical sensors 251, controller 252, following instructions contained in medium 256, may additionally coordinate the supply of cooling fluid through conduits 42 and 44 with the rate at which spreader drive 26 translates build material spreader 24 across build volume 22. Based upon signals from temperature sensors 250, controller 252 may automatically output control signals to spreader drive 26 causing spreader drive 26 to adjust the rate at which build material spreader 24 is moved across build volume 22 by spreader drive 26. For example, in response to temperature sensors 250 indicating an elevated temperature of the build material spreading surface of build material spreader 24 or in response to optical sensor 251 indicating the sticking of build material to the spreader 24 and/or the formation of grooves in the build material layer, controller 252 may output control signals reducing the speed or rate at which spreader drive 26 is translated across build volume 22 to form the next layer of build material, providing a greater amount of time for the cooling fluids to adequately cool the build material spreading surface of build material spreader 24 and/or to reduce the extent of temperature nonuniformities across the length of the build material spreader 24.

FIG. 5 schematically illustrates portions of an example 3D printing system 300. 3D printing system 300 incorporates a build material spreader cooling system similar to that shown in FIG. 4 and carries out method 100 described above. 3D printing system 300 comprises build volume 322, build material platform 324, excess build material receiver 326, build floor elevator 328, build material supply (BMS) 330, build material spreader 24, spreader drive 26, spreader cooler 28, cooling fluid supply 240, controller 252, temperature sensors and optical sensors 250/251, solidifier 334, carriage 336 and controller 340. Build material spreader 24, spreader drive 26, spreader cooler 28, cooling fluid supply 240, controller 252 and temperature sensors and optical sensors 250/251 are described above.

Build volume 322 is similar build volume 22 described above except the build volume 322 is specifically illustrated as comprising a vertically movable floor 342. Floor 342 is raised and lowered by build floor elevator 328. Build floor elevator 328 comprises an actuator to raise and lower floor 342 as build volume 322 is being filled with build material on a layer-by-layer basis and as each of the individual layers are selectively solidified by solidifier 334. In one implementation, build floor elevator 328 comprises a motor operably coupled to build floor 342 by a rack and pinion drive to linearly raise and lower floor 342. In other implementations, build floor elevator 328 may comprise other mechanisms for raising and lowering floor 342 in a controlled fashion to control the thickness of the build layers being formed during each pass of build material spreader 24.

Build material platform 324 comprises a surface adjacent to an edge of build volume 322 and upon which a mound of build material 344 may be deposited, ready for being spread across build material volume 322 by build material spreader 24. Excess build material receiver 326 extends on opposite side of build volume 322 as platform 324. Receiver 326 receives any excess build material not used to form the topmost build layer during the most recent pass of spreader 24 across build volume 322. Such excess build material may be recovered for disposal or reuse.

In one implementation, excess build material receiver 326 comprises a platform similar to platform 324. In such an implementation, the build material spreader 24 spreads build material from left to the right side. Upon reaching platform 326, the spreader 24 is lifted above the pile remnant of build material and the spreader is moved to the right of the remnant pile on platform 326. After passing the pile remnant, the spreader 24 is lowered and then driven back to the left, spreading the remnant pile of build material in the opposite direction with any excess build material being deposited into a recycling system on the left.

Build material supply 330 supplies a mound 344 of build material on top of platform 324. In one implementation, build material supply 330 comprises a pneumatic system in which build material is pneumatically carried and deposited on platform 324 across the width (into the page) of build volume 322. In some implementations, build materials supply 330 may include a vibrator for spreading the build material across the width of platform 324 along the edge of build volume 322. In other implementations, an auger may be used to convey and deposit the mound 344 of build material on platform 324. In still other implementations, other mechanisms may be used to deposit mound 344 on platform 324. For example, in some implementations, a translating hopper may be used to deposit mound 344.

Solidifier 334 carries out solidification of selected portions of the individual layers of build material in build volume 322. In one implementation, solidifier 334 comprises fusing agent deposition and heating systems, binder agent deposition systems, laser sintering systems and the like which operate on the underlying portions of the build layers in build volume 322. In some implementations, solidifier 334 comprises a chemical binding system such as powder bed and inkjet or drop on powder (binder jet 3D printing) system or metal type 3D printing system. In some implementations, solidifier 334 heats the build material to melt the build material to a point of the liquefaction prior to being solidified. In other implementations, solidifier 334 carries out sintering of the build material, wherein the build material is compacted into a solid mass of material by heat or pressure without melting to a point of liquefaction.

Carriage 336 controllably position solidifier 334 over selected portions of build volume 322. In one implementation, carriage 336 is selectively positioned opposite to selected portions of the layers of build material provided by build volume 322 by a motor and a rack and pinion drive, an electric solenoid, a hydraulic-pneumatic cylinder a piston assembly or the like to facilitate the solidification of selected portions of the layers of build material in build volume 322.

Controller 340 controls the positioning of carriage 336 as well as the solidification of portions of the build layers by solidifier 334. Controller 340 comprises memory 350 and processing unit 352. Memory 350 contains instructions for directing processing unit 352 to carry out control determinations and to output control signals to carriage 336 and solidifier 334. For example, instruction contained in memory 350 may direct processing unit 352 to access a file 354 describing the composition, shape and size of a three-dimensional object 360 to be formed on a layer-by-layer basis in build volume 322. Based upon information read from the file, processing unit 352, following instruction contained in memory 350, output signals to carriage 336 to then position solidifier 334 opposite to appropriate portions of the layer of build material. Such instructions further direct solidifier 334 to carry out a solidification process on selected portions of the layer of build material currently being presented in build volume 322. This process is repeated layer by layer until the three-dimensional object defined in the file 354 has been formed. In some implementations, once each three-dimensional object has been formed within the build volume 322, the build volume 322 may be removed from system 300 and transferred to a processing station where the formed objects are removed and the unused build material is recovered and potentially recycled. In some implementations, the unused build material is auto-extracted and recycled. In some implementations, the control functions of controller 340 and controller 252 may be combined and carried out by a single control unit.

In some implementations, solidifier 334 may have other forms and may interact with selected portions of the build material and build volume 322 in other fashions. For example, solidifier 334 may have a first portion carried by carriage 336 that selectively jets or otherwise deposits fusing agents on the build material and a second portion coupled to spreader 24 so as to be driven by spreader drive 26 and so as to complete or further carry out the solidification process (fusing or curing) with the assistance of the previously deposited fusing agents. In yet other implementations, carriage 336 may be omitted such as where solidifier 334 is carried by spreader 24 and driven by spreader drive 26 or where solidifier 334 is stationary, but is capable of interacting with a sufficient area of build volume 322. In some implementations where solidifier 324 carries out selective laser sintering, carriage 336 may be omitted.

FIG. 5 illustrates the forming of an example three-dimensional part or object 360 on a layer-by-layer basis in build volume 322. To form the next success of solidified layer of object 360, controller 340 outputs control signals causing build material supply 330 to deposit mound 344 on platform 324 along the width of build volume 322. This build material may be preheated to remove moisture and/or facilitate subsequent solidification by solidifier 334. Once the mound 344 of build material has been deposited upon platform 324, controller 252 outputs control signals causing spreader drive 26 to translate build material spreader 24 and the associated spreader cooler 28 across build volume 322, grading or pushing the mound 344 of build material over and across build volume 322. FIG. 5 illustrates the repositioning of build material spreader 24 (shown in broken lines) as it is been moved or translated across build volume 322 by spreader drive 26. As further shown in broken lines, during its movement across build volume 322, build material spreader 24 creates a new layer 3 of build material on top of build volume 322. As indicated by arrow 364, selected portions of this layer are solidified by solidifier 334, building object 360 on a layer-by-layer basis. Any remaining excess build material not used to form layer 360 is pushed into receiver 326.

As build material spreader 24 pushes the mound 344 of build material across build volume 322, the build material spreading surfaces of build material spreader 24 absorb heat (H). Such heat (H) may originate in the original mound 344 of heated build material or, as indicated by arrows 366, may be heat (H) from the existing build material in build volume 322 which may have undergone additional heating as a result of the solidification carried out by solidifier 334.

As described above, to inhibit the build material spreading surface of build material spreader 24 from heating to a temperature high enough such that the build material sticks to spreader 24, system 300 cools build material spreader 24. Cooling fluid supply 240, under the control of controller 252, directs cooling fluid in a first direction (out of the page in FIG. 5) through conduit 42. To reduce temperature differences along the length (into the page) of build material spreader 24, cooling fluid supply 240, under the control of controller 252, further directs cooling fluid in a second opposite direction through conduit 44 of spreader cooler 28. As described above with respect to system 220, the temperature the fluid being supplied through conduits 42 and 44 as well as the rate at which such cooling fluids are supplied through conduits 42 and 44 may be independently varied or adjusted by cooling fluid supply 240 in response to the control signals from controller 252, wherein such control signals may be based upon signals from temperature sensors 250 (also shown in FIG. 4) and/or signals from optical sensors 251 (shown in FIG. 4). In one implementation, controller 252 may further output control signals adjusting the rate at which build material is translated across build volume 322 by spreader drive 26 based upon signals from temperature sensors 250 and/or optical sensors 251.

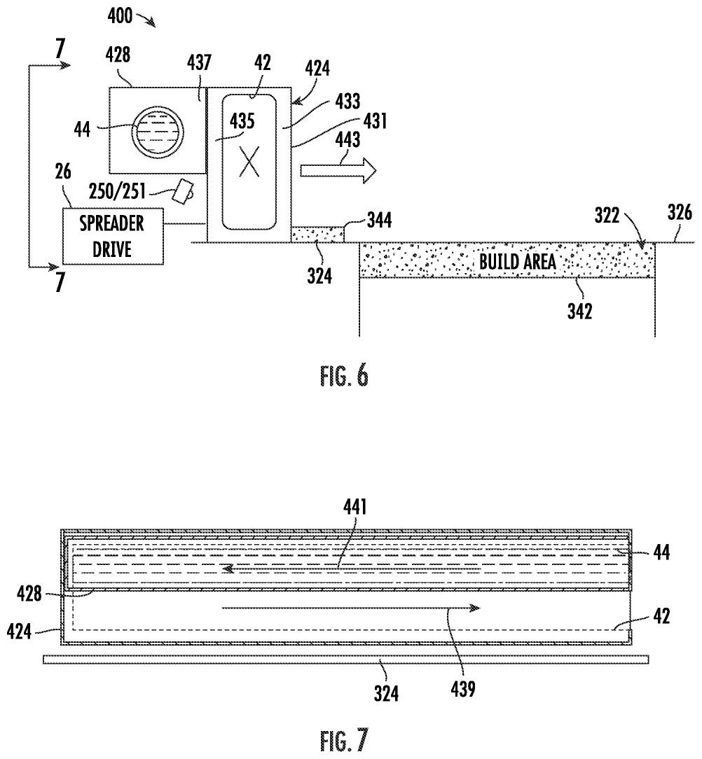

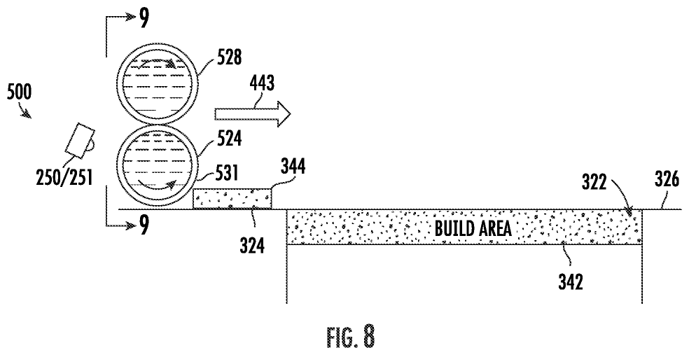

FIGS. 6 and 7 illustrate portions of an example 3D printing system 400. System 400 is similar to system 300 described above except that system 400 illustrates one example implementation of a build material spreader and associated spreader cooler. Those remaining components of system 400 which correspond to components of system 300 are numbered similarly and/or are shown in FIG. 5. In the illustrated example, system 400 comprises a build material spreader in the form of a blade 424 and a spreader cooler in the form of a separate cooling member 428 that is bonded, welded, mounted or otherwise joined to the blade 424 so as to be in thermally conductive contact with blade 424.

Blade 424 has a blade front 431 which serves as a build material spreading surface. Fluid conduit 42 is located behind blade front 431, within the blade forming spreader 424. The wall of blade front 431 and the material extending between the face of blade front 431 and the interior of conduit 42 is formed from a highly thermally conductive material such as a metal. For example, in one implementation, the material forming wall 433 may be formed from an aluminum material. In other implementations, wall 433 may be formed from other materials. As a result, heat absorbed by wall 433 is thermally conducted to the cooling fluid passing through conduit 42.

The cooling member 428 forming the spreader cooler comprises an internal fluid conduit 44. Those portions of build material spreader 428 extending between conduit 44 and conduit 42 are formed from a highly thermally conductive material such as a metal. In one implementation, the rear wall 435 of spreader 424 and the front wall 437 of build material spreader 424 are each formed from a metal, such as aluminum. As a result, heat absorbed by the cooling fluid within conduit 42 may further be thermally conducted through walls 435 and 437 to the cooling fluid circulating through fluid conduit 44.

As described above, controller 252 outputs control signals to cooling fluid supply 240 (shown in FIG. 5) so as to direct and circulate cooling fluid in a first direction (indicated by the “X”, into the page of FIG. 6) along conduit 42 (as indicated by arrow 439 in FIG. 7) and in a second opposite direction (out of the page in FIG. 6) along conduit 44 (as indicated by arrow 441 of FIG. 7). As further shown by FIG. 7, in the example illustrated, conduits 42 and 44 extend along a majority, and in some instances more than 90%, of the axial length of the blade 424. As described above with respect to system 220, the temperature and/or rate at which the cooling fluid is applied to conduit 42, and the temperature and/or rate at which cooling fluid is supplied to conduit 44, may be controlled based upon signals from the temperature sensors 250 and/or the optical sensors 251 (schematically illustrated with a single sensor unit). In some implementations, the rate that spreader drive 26 translates blade 424 (in the direction indicated by arrow 443) and the associated cooling member 428 across build volume 322 may be adjusted based upon the temperature of build blade 424 as indicated by sensors 250 or the current accumulation rate of build material on blade 424 as indicated by signals from optical sensors 251.

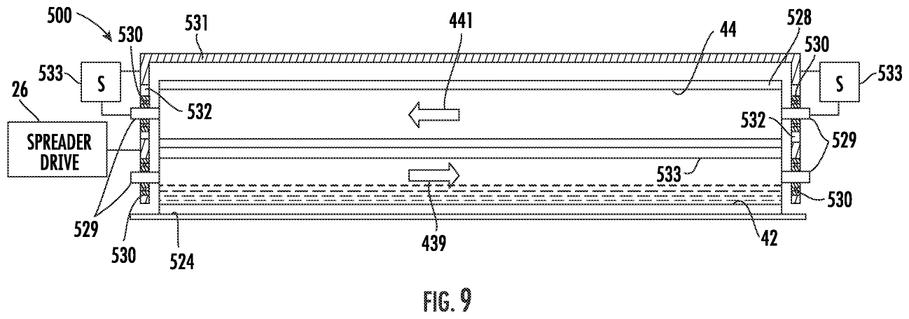

FIGS. 8 and 9 illustrate portions of an example 3D printing system 500. System 500 is similar to system 300 and system 400 described above except that system 500 illustrates one example implementation of a build material spreader and associated spreader cooler. Those remaining components of system 500 which correspond to components of system 300 and 400 are numbered similarly and/or are shown in FIG. 5. In the illustrated example, system 500 comprises a build material spreader in the form of a rotatably driven roller 524 and a spreader cooler in the form of a separate idler roller 528 in frictional thermally conductive contact with the roller 524 so as to be in thermally conductive contact with spreader 524.

Roller 524 is rotatably driven during spreading. Such rotation maintains uniform temperature on the build material spreading surface 531. The rotational speed at which roller 524 is driven is dependent upon the rate at which roller 524 is translated across the build area as indicated by arrow 443. In some implementations, roller 528 may itself be rotatably driven in unison with the driven roller 524.

Roller 524 has a roller front 531 which serves as a build material spreading surface. Roller 524 includes fluid conduit 42 which extends through and along roller 524. The wall of roller 524 is formed from a highly thermally conductive material such as a metal. For example, in one implementation, the material forming wall 533 may be formed from an aluminum material. In other implementations, wall 533 may be formed from other materials. As a result, heat absorbed by wall 533 is thermally conducted to the cooling fluid passing through conduit 42.

The roller 528 forming the spreader cooler comprises internal fluid conduit 44. The wall is formed from a highly thermally conductive material such as a metal. In one implementation, the walls of rollers 524 and 528 are formed from aluminum. The outer surface of rollers 524 and 528 are in close conformal contact so as to provide thermal conduction of heat therebetween. As a result, heat absorbed by the cooling fluid within conduit 42 may further be thermally conducted to the cooling fluid circulating through fluid conduit 44.

As shown by FIG. 9, roller 528 is held and maintained in direct physical contact with roller 524 by springs which resiliently bias roller 528 towards roller 524. In the example illustrated, end portions of rollers 524 and 528 each include axles 529. Bearing assemblies 530 rotatably support axles 529. The bearing assembly 530 supporting axles 529 of roller 524 is fixed to and supported by a main frame 531 which is translatable by spreader drive 26. Frame 531 further includes an elongate channel or slot 532 which slidably receives the bearing assemblies 530 that rotatably support axles 529 of roller 528. As a result, roller 528 is vertically movable within the channel or slot 532 towards and away from roller 524 while being rotatably supported about the axis of its axles 529.

Springs 533 are connected between the bearing assemblies 530 that rotatably support roller 528 and frame 531 so as to resiliently bias such bearing assembly 530 and the associated roller 528 towards and into contact with roller 524. In one implementation, springs 533 (schematically shown) comprises compression springs captured or connected between an upper side of bearing assemblies 530 that rotatably support roller 524 and frame 531. In another implementation, springs 533 comprise tension springs captured or connected between a lower side of the bearing assemblies 530 that rotatably support roller 524 and frame 531. In other implementations, roller 528 is moved into and out of contact with roller 524 by powered actuator, lever other mechanism. In yet other implementations, roller 528 is stationarily mounted against and in contact with roller 524.

As described above, controller 252 outputs control signals to cooling fluid supply 240 (shown in FIG. 5) so as to direct and circulate cooling fluid in a first direction along conduit 42 (as indicated by arrow 439 in FIG. 9) and in a second opposite direction (along conduit 44 (as indicated by arrow 441 of FIG. 9). As further shown by FIG. 9, in the example illustrated, conduits 42 and 44 extend along a majority, and in some instances more than 90%, of the axial length of the blade 424. As described above with respect to system 220, the temperature and/or rate at which the cooling fluid is supplied to conduit 42, and the temperature and/or rate at which cooling fluid is supplied to conduit 44, may be controlled based upon signals from the temperature sensors 250 and/or the optical sensors 251 (schematically illustrated with a single sensor unit). In some implementations, the rate that spreader drive 26 translates the pair of rollers 524, 528 (in the direction indicated by arrow 443) and the associated cooling member 428 across build volume 322 may be adjusted based upon the temperature of roller 524 (or the temperature of the fluid flowing through roller 524) as indicated by sensors 250, the current accumulation rate of build material on roller 524 as indicated by signals from optical sensors 251 or detected nonuniformities or grooves in the topmost layer of build material within the build volume 322 as indicated by optical sensors 251.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A three-dimensional (3D) printer build material spreader cooling system comprising:
a build volume;
a build material spreader having a length and comprising a first fluid conduit extending along the length;
a spreader drive to translate the build material spreader across the build volume;
a spreader cooler in thermal conductive contact with the build material spreader, the spreader cooler having a second fluid conduit extending along the length;
a cooling fluid supply to direct cooling fluid in a first direction through the first fluid conduit and in a second direction, opposite the first direction, through the second fluid conduit.

2. The build material spreader cooling system of claim 1 further comprising:
a first roller providing the build material spreader, the first conduit extending through and along the first roller; and
a second roller providing the spreader cooler in contact with the first roller along the length, the second conduit extending through and along the second roller.

3. The build material spreader cooling system of claim 1 further comprising a blade providing the build material spreader.

4. The build material spreader cooling system of claim 1, wherein the cooling fluid supply is connected to the first fluid conduit and the second fluid conduit at opposite ends of the length.

5. The build material spreader cooling system of claim 1, wherein the cooling fluid supply is to supply cooling fluid at a first temperature to the first conduit and is supply cooling fluid at a second temperature, different than the first temperature, to the second conduit.

6. The build material spreader cooling system of claim 1, wherein the cooling fluid supply is to supply cooling fluid at a first rate to the first conduit and a second rate, different than the first rate, to the second conduit.

7. The build material spreader cooling system of claim 1, wherein the cooling fluid supply is to supply a first cooling fluid composition to the first conduit and a second fluid cooling composition to the second conduit.

8. The build material spreader cooling system of claim 1 further comprising:
a temperature sensor to sense a temperature of the build material spreading surface; and
a controller to output control signals adjusting operation of the cooling fluid supply based upon signals from the temperature sensor.

9. The build material spreader cooling system of claim 8, wherein the cooling fluid supply is to change a characteristic of the cooling fluid supplied to the first conduit relative to the characteristic of the cooling fluid supplied to the second conduit in response to the control signals.

10. The build material spreader cooling system of claim 1 further comprising:
an optical sensor to sense the presence of build material on the build material spreading surface; and
a controller to output control signals adjusting operation of the cooling fluid supply based upon signals from the optical sensor.

11. The build material spreader cooling system of 1 further comprising:
an optical sensor to sense nonuniformities in a layer of build material in the build volume; and
a controller to output control signals adjusting operation of the cooling fluid supply based upon signals from the optical sensor.

12. A build material spreader cooling method comprising:
translating a build material spreader across a build volume;
directing cooling fluid in a first direction along a length of a build material spreading surface of the build material spreader; and
directing cooling fluid in a second direction, opposite the first direction, along the length of a spreader cooler that is in thermal conductive contact with the build material spreader.

13. The method of claim 12 further comprising:
sensing a temperature of the build material spreading surface; and
adjusting a characteristic of the cooling fluid being directed in the first direction based upon the sensed temperature.

14. A non-transitory computer-readable medium containing instructions to direct a processor to:
output control signals directing a cooling fluid supply to supply cooling fluid along a length of a build material spreading surface of a three-dimensional printer build material spreader;
receive signals from a sensor, the signals indicating nonuniform temperatures along the length of the build material spreading surface; and
output control signals causing the cooling fluid supply to supply cooling fluid to a spreader cooler in thermally conductive contact with the build material spreader based on the signals.

15. The non-transitory computer-readable medium of claim 14, wherein the signals received from the sensors are received from sensors selected from a group consisting of: temperature sensors; optical sensors detecting presence of build material on the build material spreading surface; optical sensors detecting nonuniformities in a layer of build material; and combinations thereof.
